(19) United States
(12) Patent Application Publication
(10) Pub. No.: US 2011/0094402 A1
(43) Pub. Date: Apr. 28, 2011

(54) TEMPLATE AND PATTERN FORMATION METHOD

(76) Inventor: Hiroshi TOKUE, Kanagawa-ken (JP)

(21) Appl. No.: 12/879,891

(22) Filed: Sep. 10, 2010

(30) Foreign Application Priority Data
Oct. 22, 2009 (JP) 2009-242977

(51) Int. Cl. B41C 3/08

(52) U.S. Cl. 101/401.1

(57) ABSTRACT

According to one embodiment, a template is provided. The template includes an unevenness provided on a first major surface. A side wall of the unevenness has a trench aligned in a depth direction of the unevenness.

### CROSS-REFERENCE TO RELATED APPLICATIONS

This application is based upon and claims the benefit of priority from the prior Japanese Patent Application No. 2009-242977, filed on Oct. 22, 2009; the entire contents of which are incorporated herein by reference.

### FIELD

Embodiments described herein relate generally to a template and a pattern formation method.

### BACKGROUND

Nanoimprinting used to transfer a master form onto a processing substrate is drawing attention as a technology to form ultra-fine patterns with high productivity when manufacturing electronic devices having ultra-fine structures such as semiconductor devices, MEMS (Micro Electro Mechanical System) devices, etc.

In nanoimprinting, a pattern is transferred onto a resin on the processing substrate by transferring the master form (the template) having the pattern to be transferred onto an organic material on the processing substrate and by curing the organic material.

During nanoimprinting, the organic material layer may be destroyed and defects of the transferred pattern may occur due to friction between the organic material and the side wall of the unevenness of the template after the curing of the organic material when template separation is performed to separate the template from the organic material.

JP-A 2007-35998 (Kokai) discusses technology to suppress the destruction, peeling, etc. of the resist by causing a value of Ra×a to be not more than 100 nm in the case of a line pattern and not more than 50 nm in the case of a hole pattern, where Ra (nm) is the side wall roughness of the unevenness configuration of the mold and a (nm) is the aspect ratio. Even when such technology is used, the defects during the template separation cannot be reduced sufficiently; and there is room for improvement.

### BRIEF DESCRIPTION OF THE DRAWINGS

FIGS. 1A and 1B are schematic views illustrating the configuration of a template according to a first embodiment;

FIGS. 2A to 2D are schematic cross-sectional views in order of the processes, illustrating a pattern formation method according to this embodiment of the invention;

FIGS. 3A to 3C are micrographs illustrating experimental results of the templates according to the first embodiment and a template of a comparative example;

FIGS. 4A to 4D are schematic cross-sectional views illustrating configurations of other templates according to the first embodiment;

FIGS. 5A and 5B are schematic cross-sectional views illustrating configurations of other templates according to the first embodiment;

FIG. 6 is a schematic cross-sectional view illustrating the configuration of another template according to the first embodiment; and

FIG. 7 is a flowchart illustrating a pattern formation method according to a second embodiment.

### DETAILED DESCRIPTION

In general, according to one embodiment, a template includes an unevenness provided on a first major surface. A side wall of the unevenness has a trench aligned in a depth direction of the unevenness.

According to one embodiment, a pattern formation method is disclosed. The method can include transferring a pattern of an unevenness provided on a first major surface of a template onto a transfer material provided on a major surface of a processing substrate by bringing the first major surface into contact with the transfer material. The template has a trench provided in a side wall of the unevenness to align in a depth direction of the unevenness.

Exemplary embodiments of the invention will now be described with reference to the drawings.

The drawings are schematic or conceptual; and the relationships between the thickness and width of portions, the proportional coefficients of sizes among portions, etc., are not necessarily the same as the actual values thereof. Further, the dimensions and proportional coefficients may be illustrated differently among the drawings, even for identical portions.

In the specification and the drawings of the application, components similar to those described in regard to a drawing thereinabove are marked with like reference numerals, and a detailed description is omitted as appropriate.

### First Embodiment

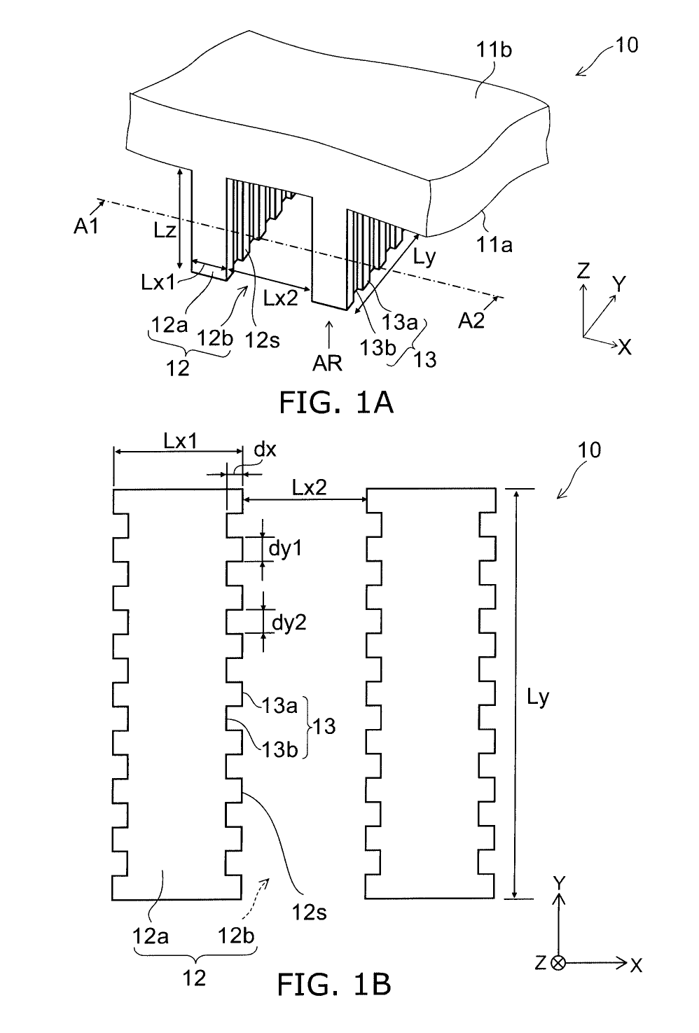

FIGS. 1A and 1B are schematic views illustrating the configuration of a template according to a first embodiment of the invention. Namely, FIG. 1A is a schematic perspective view. FIG. 1B is a cross-sectional view along line A1-A2 of FIG. 1A illustrating the planar configuration of a protruding portion 12a as viewed from the direction of arrow AR of FIG. 1A.

As illustrated in FIGS. 1A and 1B, the template 10 according to this embodiment of the invention includes an unevenness 12 provided on a transfer surface 11a (a first major surface). The unevenness 12 includes at least one selected from the protruding portion 12a and a recessed portion 12b. For example, in the case where the recessed portion 12b is provided in the transfer surface 11a, the portions other than the recessed portion 12b are taken as the protruding portion 12a; and in the case where the protruding portion 12a is provided in the transfer surface 11a, the portions other than the protruding portion 12a are taken as the recessed portion 12b. The recessed portion 12b and the protruding portion 12a are relative to each other. For example, one protruding portion 12a may be provided in the transfer surface 11a. Also, one recessed portion 12b may be provided in the transfer surface 11a.

As described below, the transfer surface 11a is the face brought into contact with a transfer material provided on a major surface of a processing substrate. The unevenness 12 of the transfer surface 11a is the unevenness that transfers the pattern configuration onto the transfer material by the transfer surface 11a contacting the transfer material.

Herein, a direction perpendicular to the transfer surface 11a of the template 10 is taken as a Z-axis direction. One direction perpendicular to the Z-axis direction is taken as an X-axis direction (a first direction). A direction perpendicular to the Z-axis direction and the X-axis direction is taken as a Y-axis direction (a second direction).

The protruding portion 12a of the unevenness 12 has a width along the X-axis direction (a protruding portion width Lx1) and a length along the Y-axis direction (a protruding portion length Ly). In this specific example, the unevenness 12 is multiply provided. The portion between the multiple protruding portions 12a corresponds to the recessed portion 12b. The recessed portion 12b has a width along the X-axis direction (a recessed portion width Lx2). The length along the Y-axis direction of the recessed portion 12b is the same as the protruding portion length Ly. A depth Lz of the unevenness 12 is the depth of the recessed portion 12b (the length along the Z-axis direction of the recessed portion 12b), that is, the height of the protruding portion 12a (the length along the Z-axis direction of the protruding portion 12a).

The planar configuration (the pattern configuration as viewed from the Z-axis direction) of the recessed portion 12b (and the protruding portion 12a) is arbitrary and may be, for example, a trench configuration aligned in one direction, a rectangular or square configuration, a flattened circular or circular configuration, or any polygonal configuration.

The case is described hereinbelow where the planar configuration (the pattern configuration as viewed from the Z-axis direction) of the recessed portion 12b (and the protruding portion 12a) is a trench configuration.

In the template 10 according to this embodiment, a side wall 12s of the unevenness 12 has a trench 13b aligned in the depth direction of the unevenness 12 (the Z-axis direction).

In other words, a line-shaped unevenness 13 having a line configuration aligned in the Z-axis direction is provided in the side wall 12s of the unevenness 12; the portion of the line-shaped unevenness 13 recessed from the side wall 12s defines the trench 13b; and the portions other than the trench 13b form a line-shaped protruding portion 13a.

The trench 13b of the line-shaped unevenness 13 has a width along the Y-axis direction (a trench width dy2) and a length along the X-axis direction (a trench depth dx). In this specific example, the line-shaped unevenness 13 is multiply provided. The portion between the multiple trenches 13b corresponds to the line-shaped protruding portion 13a. The line-shaped protruding portion 13a has a width along the Y-axis direction (a line-shaped protruding portion width dy1). The length (the height) along the X-axis direction of the line-shaped protruding portion 13a is the same as the trench depth dx.

In the case where the trench 13b and the line-shaped protruding portion 13a are multiply provided, the depths and the widths of the multiple trenches 13b may be different from each other; and the depths and the widths of the multiple line-shaped protruding portions 13a may be different from each other.

Although the trenches 13b oppose each other along the X-axis direction and the line-shaped protruding portions 13a oppose each other along the X-axis direction for two side walls 12s (the side walls opposing each other in the X-axis direction) of one protruding portion 12a as illustrated in FIG. 1B, this embodiment is not limited thereto. In other words, for one protruding portion 12a, the positional relationship along the Y-axis direction of the trenches 13b is arbitrary; and the positional relationship along the Y-axis direction of the line-shaped protruding portions 13a is arbitrary. Even in the case where the line-shaped protruding portions 13a do not oppose each other along the X-axis direction for one protruding portion 12a, the protruding portion width Lx1 is taken as the width along the X-axis direction between the line-shaped protruding portions 13a opposing each other across the protruding portion 12a.

Moreover, although the trenches 13b provided on mutually proximal side walls 12s of two adjacent protruding portions 12a oppose each other along the X-axis direction and the line-shaped protruding portions 13a provided on mutually proximal side walls 12s of two adjacent protruding portions 12a oppose each other along the X-axis direction in this specific example, this embodiment is not limited thereto. In other words, the positional relationship along the Y-axis direction of the trenches 13b of mutually proximal side walls 12s of two adjacent protruding portions 12a is arbitrary; and the positional relationship along the Y-axis direction of the line-shaped protruding portions 13a of mutually proximal side walls 12s of two adjacent protruding portions 12a is arbitrary. Even in the case where the line-shaped protruding portions 13a of mutually proximal side walls 12s of two adjacent protruding portions 12a do not oppose each other along the X-axis direction, the recessed portion width Lx2 is taken as the width along the X-axis direction between the line-shaped protruding portions 13a opposing each other across the recessed portion 12b.

The protruding portion width Lx1 may be, for example, 10 nm (nanometers) to 1 μm (micrometer). The protruding portion length Ly may be, for example, 20 μm to 100 μm. The recessed portion width Lx2 may be, for example, 10 nm to 1 μm. The depth Lz may be, for example, 10 nm to 200 nm. The trench width dy2 may be, for example, 1 nm to 100 nm. The trench depth dx may be, for example, 1 nm to 20 nm. The line-shaped protruding portion width dy1 may be, for example, 1 nm to 100 nm. However, such values are examples; and this embodiment is not limited thereto. Any value may be used. The protruding portion width Lx1 may be, for example, 20 nm to 30 nm; the protruding portion length Ly may be, for example, 20 nm to 30 nm; and the depth Lz may be, for example, 20 nm to 200 nm.

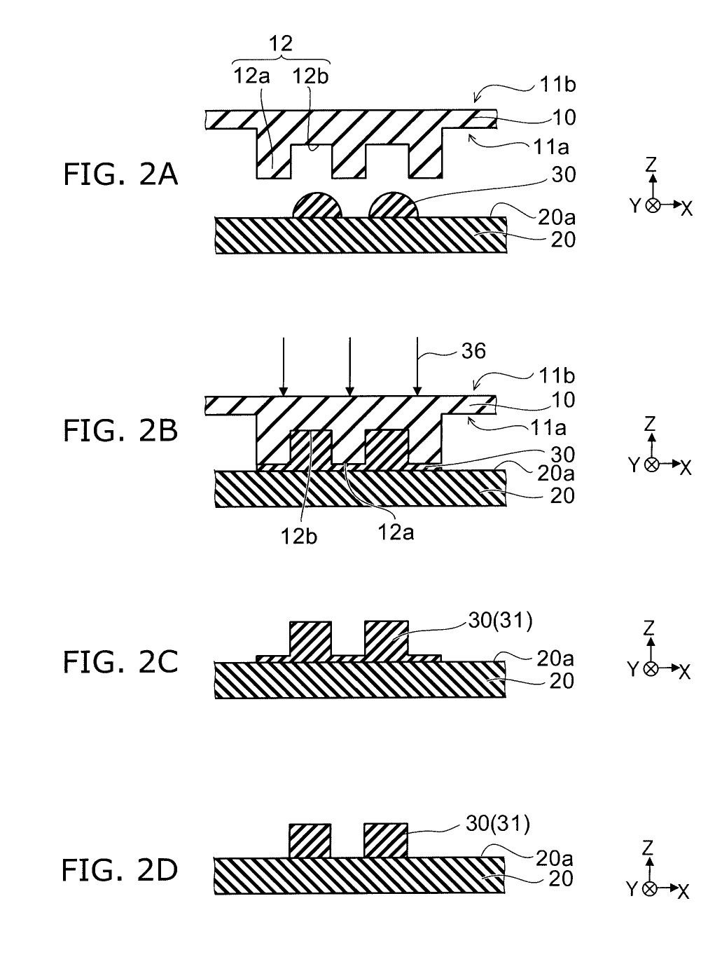

An example of a pattern formation method using such a template 10 will now be described. FIGS. 2A to 2D are schematic cross-sectional views in order of the processes, illustrating the pattern formation method according to this embodiment of the invention.

As illustrated in FIG. 2A, the template 10 is disposed such that the transfer surface 11a of the template 10 (the face where the unevenness 12 is provided) opposes a transfer material 30 provided on a major surface 20a of a processing substrate 20. Any method using, for example, an inkjet, a spinner, etc., may be used to form the transfer material 30 on the major surface 20a of the processing substrate 20. In such a state, the transfer material 30 is, for example, a liquid. For example, the processing substrate 20 may include a film to be patterned (not illustrated); and the major surface 20a may be taken to be the upper face of the film to be patterned of the processing substrate 20.

Then, as illustrated in FIG. 2B, the distance between the processing substrate 20 and the template 10 is reduced to bring the transfer surface 11a of the template 10 and the transfer material 30 into contact with each other. The transfer material 30 is a liquid and therefore enters into the recessed portion 12b due to capillary action; and the recessed portion 12b is filled with the transfer material 30. Thereby, the configuration of the transfer material 30 changes to a configuration conforming to the configuration of the unevenness 12 (the configuration of the recessed portion 12b and the protruding portion 12a). By curing the transfer material 30 in such a state, the pattern configuration of the unevenness 12 is transferred onto the transfer material 30. In the case where, for example, the transfer material 30 is a photocurable resin, a light 36 that causes the curing to progress is irradiated onto the transfer material 30 from, for example, the direction of a bottom face 11b of the template 10. The light 36 may include, for example, ultraviolet light having a wavelength of about 300 nm to 400 nm. In such a case, the material of the template 10 may be transparent to the light 36. Heating may be performed in the case where a thermosetting resin is used as the transfer material 30.

Thereby, a cured transfer layer 31 is formed from the liquid transfer material 30; and the configuration of the unevenness 12 of the template 10 is transferred onto the surface of the transfer layer 31.

At this time, the protruding portion 12a of the template 10 is not completely in contact with the processing substrate 20; the transfer material 30 exists between the template 10 and the processing substrate 20; and the transfer layer 31 is formed also at the portion between the processing substrate 20 and the protruding portion 12a of the template 10.

Then, as illustrated in FIG. 2C, the distance between the processing substrate 20 and the template 10 is increased; and the transfer layer 31 and the template 10 are separated from each other. In other words, a template separation is performed. At this time, the transfer layer 31 existing between the template 10 and the processing substrate 20 is left as a residual film.

As illustrated in FIG. 2D, etch-back is performed on the entire transfer layer 31 by, for example, anisotropic RIE (Reactive Ion Etching) and the like; and the residual film recited above is removed.

Thus, the transfer process of transferring the pattern of the unevenness 12 onto the transfer material 30 is completed. The transfer layer 31 having the pattern transferred thereto may be used, for example, as a mask when etching a film to be patterned (not illustrated) provided on the processing substrate 20.

Although destruction of the transfer layer 31 may occur and defects of the pattern of the transfer layer 31 may occur due to friction between the transfer layer 31 and the side wall 12s of the unevenness 12 of the template 10 during the template separation process of separating the transfer layer 31 and the template 10 from each other described in regard to FIG. 2C recited above, the defects of the pattern of the transfer layer 31 can be suppressed by the template 10 according to this embodiment by providing the trench 13b in the side wall 12s of the unevenness 12 to align in the depth direction of the unevenness 12.

In other words, during the template separation, for example, the template 10 is lifted upward and the template 10 is pulled away from the transfer layer 31. When lifting the template 10, the template 10 deforms in a downward convex configuration while being lifted. In other words, the template 10 is lifted in a state in which the peripheral portion of the template 10 is positioned higher than the central portion. This is because, due to the adhesion strength between the template 10 and the transfer layer 31, the template 10 and the transfer layer 31 do not separate easily at the central portion of the template 10; and the template 10 and the transfer layer 31 separate more easily at the peripheral portion of the template 10. Because the template 10 deforms in the downward convex configuration, the unevenness 12 of the template 10 is lifted in a direction not perpendicular to the transfer layer 31 but in a direction oblique to the transfer layer 31. In other words, the relative positions of the transfer layer 31 and the unevenness 12 of at least a portion (e.g., the peripheral portion) of the template 10 change along a direction oblique to the Z-axis direction.

At this time, in the case of a comparative example in which trenches and the like are not provided on the side wall 12s of the unevenness 12 and the side wall 12s is flat, the contact between the transfer layer 31 and the side wall 12s of the template 10 is a surface contact when the unevenness 12 of the template 10 is lifted in the oblique direction. Therefore, the friction force between the transfer layer 31 and the side wall 12s of the template 10 is large; and the load on the transfer layer 31 is large. Therefore, defects easily occur in the transfer layer 31 during the template separation.

Conversely, the trench 13b (and the line-shaped protruding portion 13a) is provided in the side wall 12s of the unevenness 12 in the template 10 according to this embodiment. Therefore, when the unevenness 12 of the template 10 is lifted in the oblique direction, the contact between the transfer layer 31 and the side wall 12s of the template 10 changes from the surface contact to a line contact (or a point contact). Therefore, the friction force between the transfer layer 31 and the side wall 12s of the template 10 decreases; and the load on the transfer layer 31 decreases. Thereby, the defects occurring in the transfer layer 31 during the template separation are suppressed.

Thus, defects can be suppressed by the template 10 according to this embodiment.

In the configuration discussed in JP-A 2007-35998 (Kokai), the side wall of the unevenness is a face having a value of Ra (the side wall roughness)×a (the aspect ratio) of not more than a constant value. In such an example, an unevenness having a value of Ra×a of not more than a constant is provided in the side wall by controlling Si etching conditions. The unevenness is made at random on the wall surface of the side wall. Therefore, the unevenness does not release when the template is lifted from the transfer layer; the template does not separate easily from the transfer layer; and there is a risk that the transfer layer may be destroyed by stress. Further, in this example, it is attempted to use a flat side wall having the value of Ra×a of not more than the constant. Therefore, in the method discussed in JP-A 2007-35998 (Kokai), the transfer layer may be destroyed easily due to the stress in the case where the unevenness does not release; the transfer layer may be destroyed easily due to the friction force between the transfer layer and the side wall in the case where the side wall is relatively flat; or both may occur.

Conversely, in the template 10 according to this embodiment, the trench 13b (and the line-shaped protruding portion 13a) is provided in the side wall 12s of the unevenness 12 to align in the depth direction. Therefore, the trench 13b (and the line-shaped protruding portion 13a) releases and the template 10 can easily separate from the transfer layer 31. Moreover, the defects due to the friction force between the transfer layer 31 and the side wall 12s do not occur easily.

Defects occur easily during the template separation in the case where the depth Lz of the unevenness 12 of the template 10 is deep (large) because a large friction force is applied to the transfer layer 31 contacting the side wall 12s of the template 10 for a long time during the template separation. Therefore, the suppression effects of the defects by the template 10 according to this embodiment are exhibited more effectively in the case where the depth Lz of the unevenness 12 of the template 10 is deep. The depth Lz of the unevenness 12 of the template 10 is determined by the desired depth (height) of the transfer layer 31. For example, the depth Lz of the unevenness 12 may be, for example, about several tens of nanometers to several hundreds of nanometers (e.g., 10 nm to 200 nm).

In the template 10 according to this embodiment, it is desirable for the depth along the X-axis direction of the trench 13b (the trench depth dx) of the side wall 12s to be not more than 1/10 of the width along the X-axis direction of the protruding portion (the protruding portion width Lx1) of the unevenness 12. In the case where the trench depth dx is greater than 1/10 of the protruding portion width Lx1, the planarity of the side wall of the unevenness of the transfer layer 31 transferred from the unevenness 12 easily decreases; and the patternability of the processing film in subsequent processes easily deteriorates. Further, in some cases, the side wall of the unevenness of the transfer layer 31 may be destroyed.

In the case where the trench 13b is multiply provided, it is desirable for the widths of the trenches 13b (the trench widths dy2) to be not more than 1/10 of the protruding portion length Ly. Also, in the case where the trench 13b is multiply provided, it is desirable for the spacing between the trenches 13b (i.e., the line-shaped protruding portion width dy1 of the line-shaped protruding portion 13a) to be not more than 1/10 of the protruding portion length Ly. In other words, in the case where the width of the trench 13b or the spacing between the trenches 13b is too large, the suppression effects of the occurrence of the defects recited above may decrease.

In other words, the trench 13b has a depth (the trench depth dx) along the first direction (the X-axis direction) orthogonal to the depth direction of the unevenness 12 (the Z-axis direction) and a width (the trench width dy2) along the second direction (the Y-axis direction) orthogonal to the Z-axis direction and the X-axis direction. The trench 13b may be multiply provided to align in the Y-axis direction. It is desirable for the length along the Y-axis direction of at least one selected from the widths of the multiple trenches 13b (the trench widths dy2) and the spacing between the trenches 13b (i.e., the line-shaped protruding portion width dy1 of the line-shaped protruding portion 13a) to be not more than 1/10 of the length (the protruding portion length Ly) along the Y-axis direction of the protruding portion 12a of the unevenness 12. In the case of such conditions, the suppression effects of the occurrence of the defects recited above can be exhibited more strongly.

However, this embodiment of the invention is not limited thereto. The widths of the multiple trenches 13b and the spacing between the trenches 13b are arbitrary.

Experimental results related to this embodiment compared to a comparative example will now be described.

In this experiment, a template 10a and a template 10b were prepared as two types of templates according to this embodiment. A template 19 was prepared as the comparative example.

Table 1 illustrates the specifications of the templates.

TABLE 1

| | 10a | 10b | 19 |
|---|---|---|---|
| dx (nm) | 3 | 3 | 0 |
| dy1 (nm) | 60 | 60 | 0 |
| dy2 (nm) | 10 | 15 | 0 |
| Lx1 (nm) | 80 | 80 | 80 |
| Lx2 (nm) | 80 | 80 | 80 |
| DD | 300 | 400 | 3300 |
| (pcs/cm²) | | | |

For the template 10a according to this embodiment as illustrated in Table 1, the trench depth dx was 3 nm; the line-shaped protruding portion width dy1 was 60 nm; and the trench width dy2 was 10 nm. For the template 10b according to this embodiment, the trench depth dx was 3 nm; the line-shaped protruding portion width dy1 was 60 nm; and the trench width dy2 was 15 nm. For the template 19 of the comparative example, the trench depth dx, the line-shaped protruding portion width dy1, and the trench width dy2 were 0 nm. In other words, in the template 19, trenches were not provided in the side wall 12s of the unevenness 12; and the surface of the side wall 12s was flat. For the templates 10a, 10b, and 19, the protruding portion width Lx1 was 80 nm; and the recessed portion width Lx2 was 80 nm. The protruding portion length Ly was 145 μm. The depth Lz was 200 nm.

Such templates 10a, 10b, and 19 were formed by providing a resist film of, for example, a Cr film and the like on the major surface of a base material used to form the template, performing, for example, electron-beam lithography on the resist film to form the pattern configurations illustrated in Table 1, and performing, for example, dry etching on the base material using the resist film as a mask. Thus, except for the electron-beam lithography pattern, the templates 10a and 10b according to this embodiment can be manufactured by processes similar to those of the comparative example. Quartz was used as the base material recited above. However, in this embodiment, the material of the base material (i.e., the template) is arbitrary.

Using such templates 10a, 10b, and 19, the transfer layers 31 were formed by transferring the unevenness 12 of the templates onto the transfer material 30 on the processing substrate 20 using the processes described in regard to FIGS. 2A to 2D.

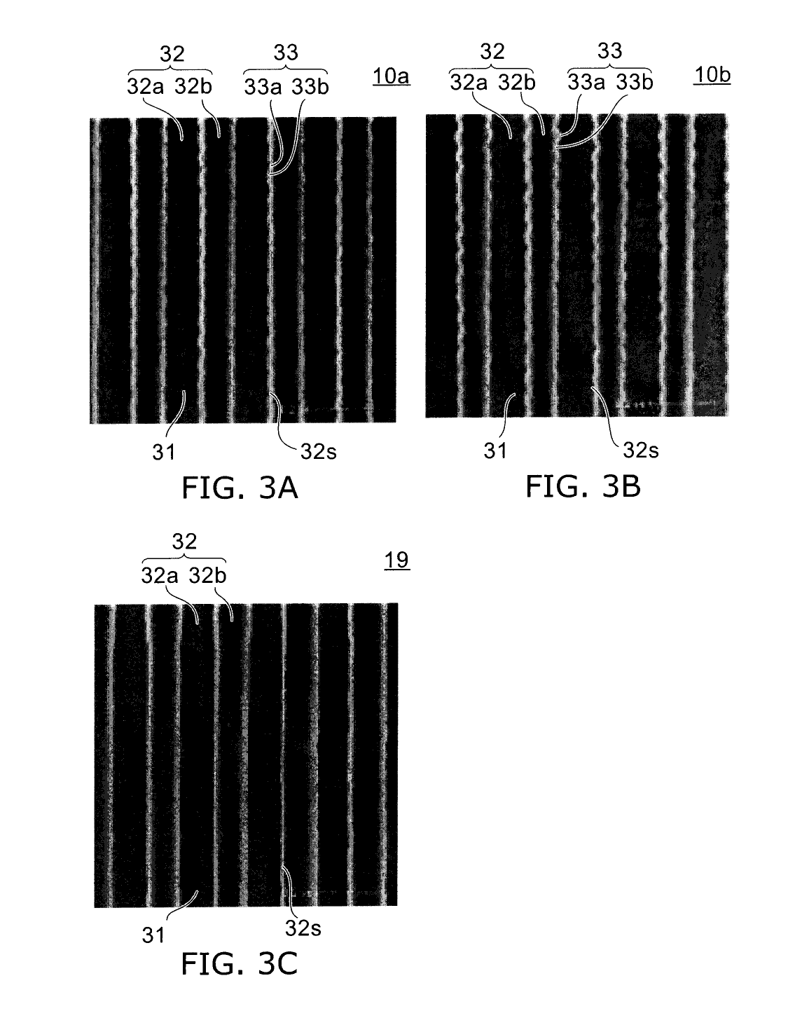

FIGS. 3A to 3C are micrographs illustrating the experimental results of the templates according to the first embodiment of the invention and the template of the comparative example.

Namely, FIGS. 3A to 3C are scanning electron micrographs photographed from the Z-axis direction to illustrate the transfer layers 31 formed using the templates 10a, 10b, and 19, respectively.

In the case where the template 10a according to this embodiment was used as illustrated in FIG. 3A, an unevenness 32 was formed in the transfer layer 31. A protruding portion 32a corresponding to the recessed portion 12b of the template 10a and a recessed portion 32b corresponding to the protruding portion 12a of the template 10a were formed in the unevenness 32 of the transfer layer 31. A line-shaped unevenness 33 was formed in the side wall 32s of the unevenness 32 of the transfer layer 31 to align in the Z-axis direction. A line-shaped protruding portion 33a corresponding to the trench 13b of the template 10a and a trench 33b corresponding to the line-shaped protruding portion 13a of the template 10a were formed in the line-shaped unevenness 33 of the side wall 32s of the transfer layer 31.

As illustrated in FIG. 3B, in the case where the template 10b according to this embodiment was used as well, the unevenness 32 including the protruding portion 32a and the recessed portion 32b was formed in the transfer layer 31. The line-shaped unevenness 33 including the line-shaped protruding portion 33a and the trench 33b was formed in the side wall 32s of the unevenness 32 of the transfer layer 31.

On the other hand, although the unevenness 32 including the protruding portion 32a and the recessed portion 32b was formed in the transfer layer 31 in the case where the template 19 of the comparative example was used as illustrated in FIG. 3C, a line-shaped unevenness is not formed in the side wall 32s of the unevenness 32 of the transfer layer 31. In other words, the side wall 32s of the unevenness 32 of the transfer layer 31 is flat.

Thus, configurations corresponding to the planar configurations of the side walls 12s of the unevenness 12 of the templates 10a, 10b, and 19 were transferred onto the side walls 32s of the unevenness 32 of the transfer layers 31 formed using the templates 10a, 10b, and 19.

Table 1 recited above illustrates the results of measuring defect densities DD of the patterns of the transfer layers 31 formed using the templates 10a, 10b, and 19.

In the case of the templates 10a and 10b according to this embodiment as illustrated in Table 1, the defect densities DD (pcs/cm², i.e., defects/cm²) were 300 pcs/cm² and 400 pcs/cm², respectively. Conversely, the defect density DD of the template 19 of the comparative example was 3300 pcs/cm².

Thus, by using the templates 10a and 10b according to this embodiment, the defect density DD was reduced markedly to about 9% to 12% of that of the template 19 of the comparative example.

Thus, the template according to this embodiment can suppress the defects of the transfer layer 31. In particular, the defects occurring during the template separation described in regard to FIG. 2C can be deterred.

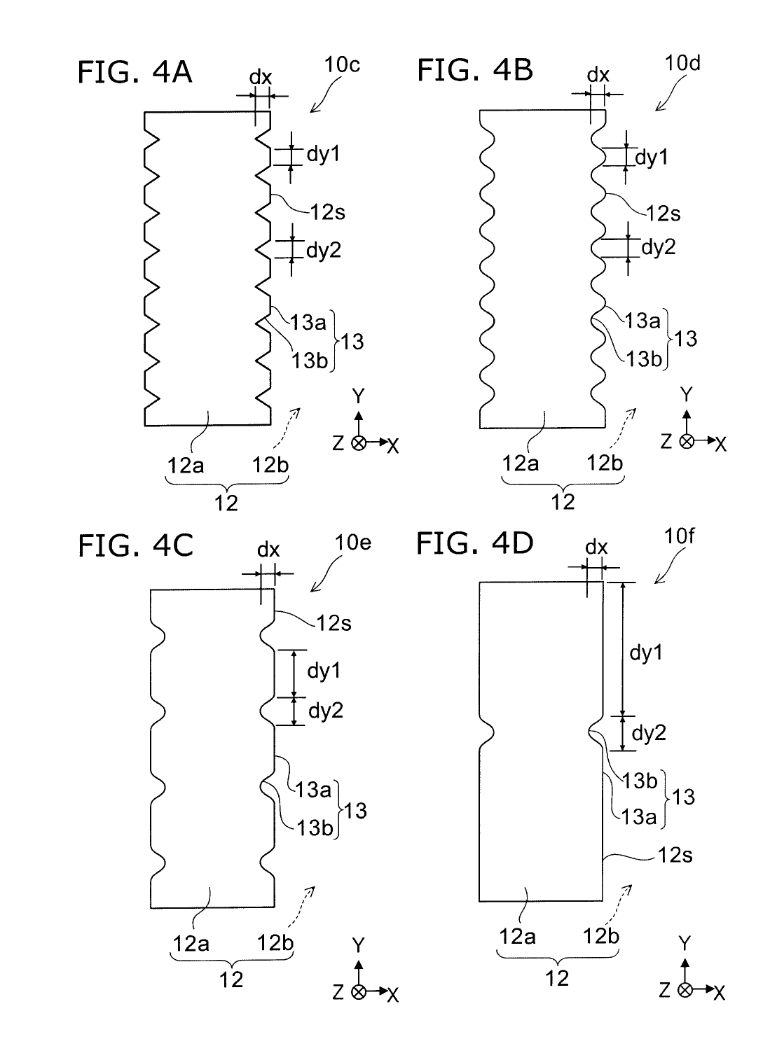

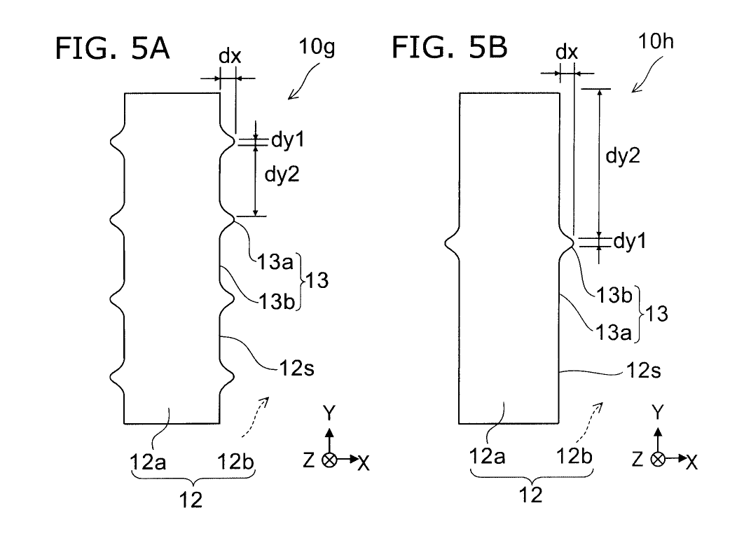

FIGS. 4A to 4D and FIGS. 5A and 5B are schematic cross-sectional views illustrating configurations of other templates according to the first embodiment of the invention.

Namely, these drawings are cross-sectional views corresponding to the cross section along A1-A2 of FIG. 1A illustrating planar configurations of the protruding portion 12a as viewed from the direction of arrow AR of FIG. 1A.

In another template 10c according to this embodiment as illustrated in FIG. 4A, the cross section (the cross section cut by the X-Y plane) of the trench 13b of the side wall 12s of the unevenness 12 is triangular. In other words, the cross-sectional configuration of the trench 13b is, for example, an equilateral triangle having a side of 3 nm. Such a trench 13b is multiply provided with, for example, a spacing (the line-shaped protruding portion width dy1) of 3 nm. The surface of the line-shaped protruding portion 13a is flat. The trench width dy2 of the trench 13b is taken as the spacing between the flat portions.

In another template 10d according to this embodiment as illustrated in FIG. 4B, the cross section (the cross section cut by the X-Y plane) of the trench 13b of the side wall 12s of the unevenness 12 has a wave-like configuration. In other words, the cross-sectional configuration of the trench 13b is, for example, a wave-like configuration having an amplitude (the trench depth dx) of 3 nm and a wavelength of 3 nm. Such a trench 13b is multiply provided with, for example, a spacing of 3 nm. The trench width dy2 of the trench 13b and the line-shaped protruding portion width dy1 are taken as the lengths between the midpoints of the lengths along the X-axis direction of the trench 13b and the line-shaped protruding portion 13a, respectively.

In another template 10e according to this embodiment as illustrated in FIG. 4C, the cross section (the cross section cut by the X-Y plane) of the trench 13b of the side wall 12s of the unevenness 12 has a wave-like configuration. The surface of the line-shaped protruding portion 13a is flat. In other words, the cross-sectional configuration of the trench 13b is, for example, half a period of a waveform having an amplitude (the trench depth dx) of 3 nm and a wavelength of 6 nm. Such a trench 13b is multiply provided with, for example, a spacing (the line-shaped protruding portion width dy1) of 9 nm.

In another template 10f according to this embodiment as illustrated in FIG. 4D, one trench 13b is provided in the side wall 12s of the unevenness 12. The cross section (the cross section cut by the X-Y plane) of the trench 13b has a wave-like configuration. The surface of the line-shaped protruding portion 13a is flat. The cross-sectional configuration of the trench 13b is, for example, a half period of a waveform having an amplitude (the trench depth dx) of 3 nm and a wavelength of 6 nm. Thus, the number of the trenches 13b provided in the side wall 12s of the unevenness 12 may be one.

In another template 10g according to this embodiment as illustrated in FIG. 5A, the cross section (the cross section cut by the X-Y plane) of the line-shaped protruding portion 13a of the side wall 12s of the unevenness 12 has a wave-like configuration. The surface of the trench 13b is flat. The cross-sectional configuration of the line-shaped protruding portion 13a is, for example, a half period of a waveform having an amplitude (the trench depth dx) of 3 nm and a wavelength of 6 nm. Such a line-shaped protruding portion 13a is multiply provided, for example, with a spacing (the trench width dy2) of 9 nm. As illustrated in FIG. 4C and FIG. 5A, the relationship between the sizes of the width of the trench 13b (the trench width dy2, i.e., the width along the Y-axis direction) and the width of the line-shaped protruding portion 13a (the line-shaped protruding portion width dy1, i.e., the width along the Y-axis direction) of the side wall 12s of the unevenness 12 is arbitrary.

In another template 10h according to this embodiment as illustrated in FIG. 5B, one line-shaped protruding portion 13a is provided in the side wall 12s of the unevenness 12. The cross section (the cross section cut by the X-Y plane) of the line-shaped protruding portion 13a has a wave-like configuration. The surface (the bottom face) of the trench 13b is flat. The cross-sectional configuration of the line-shaped protruding portion 13a is, for example, a half period of a waveform having an amplitude (the trench depth dx) of 3 nm and a wavelength of 6 nm. Thus, the number of the line-shaped protruding portions 13a provided in the side wall 12s of the unevenness 12 may be one.

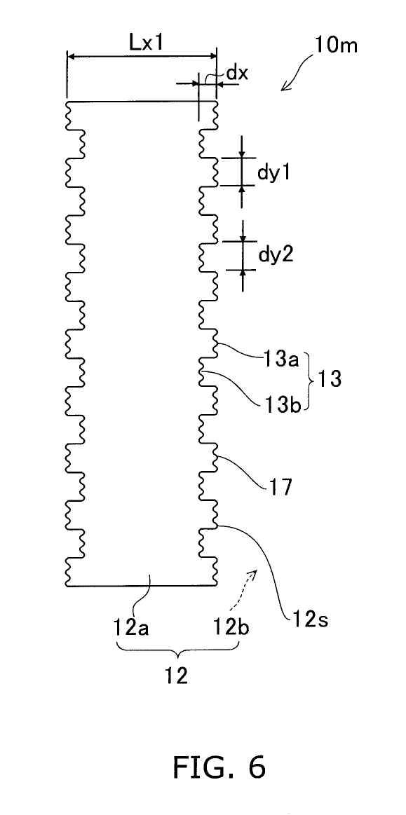

FIG. 6 is a schematic cross-sectional view illustrating the configuration of another template according to the first embodiment of the invention.

Namely, FIG. 6 is a cross-sectional view corresponding to the cross section along line A1-A2 of FIG. 1A illustrating the cross-sectional configuration of the protruding portion 12a as viewed from the direction of arrow AR of FIG. 1A.

In the template 10m according to this embodiment of the invention as illustrated in FIG. 6, an ultra-fine unevenness 17 is further provided in the side wall 12s of the template 10 illustrated in FIGS. 1A and 1B.

In other words, the ultra-fine unevenness 17 is further provided in the side wall 12s by, for example, performing wet processing on the side wall 12s after forming the line-shaped unevenness 13 (the trench 13b and the line-shaped protruding portion 13a) in the side wall 12s. The depth of the ultra-fine unevenness 17 is shallower than the depth of the line-shaped unevenness 13 (the trench 13b and the line-shaped protruding portion 13a). The size (the width) of the ultra-fine unevenness 17 is smaller than the size (the width) of the line-shaped unevenness 13 (the trench 13b and the line-shaped protruding portion 13a).

By performing the wet processing on the side wall 12s to form such ultra-fine unevenness, the configurations of the corners of the line-shaped unevenness 13 (e.g., the portion where the trench 13b contacts the line-shaped protruding portion 13a) become rounded. Thereby, the surface of the transferred transfer layer 31 can be smooth. Thereby, defects due to peeling a portion of the transfer layer 31, etc., are suppressed. Further, the life of the template 10 can be extended.

Thus, the side wall 12s of the unevenness 12 may have the ultra-fine unevenness 17 which has a depth shallower than the depth (the trench depth dx) of the trench 13b. Such an ultra-fine unevenness 17 can be provided in any of the templates 10a to 10h recited above according to this embodiment of the invention. The width of the ultra-fine unevenness 17 may be narrower than the width (the trench width dy2) of the trench 13b.

### Second Embodiment

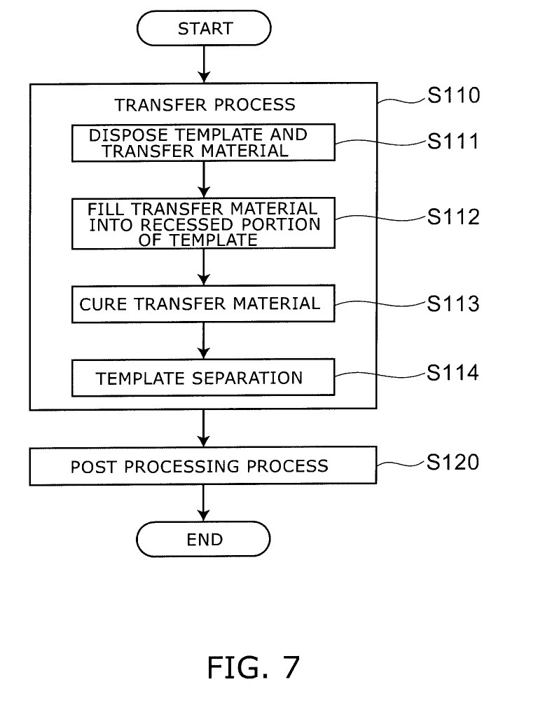

FIG. 7 is a flowchart illustrating a pattern formation method according to a second embodiment of the invention.

In the pattern formation method according to this embodiment as illustrated in FIG. 7, the pattern of the unevenness 12 is transferred onto the transfer material 30 by bringing the transfer surface 11a (the first major surface) of the template into contact with the transfer material 30 provided on the major surface 20a of the processing substrate 20, where the template has the trench 13b provided in the side wall 12s of the unevenness 12 provided on the transfer surface 11a, and the trench 13b aligns in the depth direction of the unevenness 12 (the Z-axis direction) (step S110).

In such a case, a template including the trench 13b aligned in the depth direction of the unevenness 12 (the Z-axis direction) in the side wall 12s of the unevenness 12 of the template is used as the template 10. Thereby, the defects of the transfer layer 31 can be suppressed.

In the transfer process recited above, the processes described in regard to FIGS. 2A to 2C, for example, are performed.

In other words, as described in regard to FIG. 2A, the template 10 and the transfer material 30 provided on the major surface 20a of the processing substrate 20 are disposed such that the transfer surface 11a of the template 10 opposes the transfer material 30 (step S111).

Then, as described in regard to FIG. 2B, the transfer surface 11a of the template 10 and the transfer material 30 are brought into contact with each other; and the transfer material 30 is filled into the recessed portion 12b (step S112).

Then, the transfer material 30 is cured (step S113); and the transfer layer 31 is obtained.

Subsequently, as described in regard to FIG. 2C, template separation is performed by separating the transfer layer 31 and the template 10 from each other (step S114).

At this time, during the template separation as described above, the relative positions of the transfer layer 31 and the unevenness 12 of at least a portion (e.g., the peripheral portion) of the template 10 change along a direction oblique to the Z-axis direction.

At this time, by providing the trench 13b in the side wall 12s of the unevenness 12 as described above, the load on the transfer layer 31 is reduced; and the defects occurring in the transfer layer 31 during the template separation are suppressed.

As described above, the pattern formation method according to this embodiment may further include a post processing process (step S120) of etching the transfer layer 31 to expose at least a portion of the major surface 20a of the processing substrate 20.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the invention is not limited to these specific examples. For example, one skilled in the art may similarly practice the invention by appropriately selecting specific configurations of components included in templates such as transfer surfaces, unevenness, protruding portions, recessed portions, side walls, line-shaped unevenness, line-shaped protruding portions, trenches, and the like from known art. Such practice is included in the scope of the invention to the extent that similar effects thereto are obtained.

Further, any two or more components of the specific examples may be combined within the extent of technical feasibility; and are included in the scope of the invention to the extent that the purport of the invention is included.

Moreover, all templates and pattern formation methods practicable by an appropriate design modification by one skilled in the art based on the templates and the pattern formation methods described above as exemplary embodiments of the invention also are within the scope of the invention to the extent that the purport of the invention is included.

Furthermore, various modifications and alterations within the spirit of the invention will be readily apparent to those skilled in the art. All such modifications and alterations should therefore be seen as within the scope of the invention. For example, additions, deletions, or design modifications of components or additions, omissions, or condition modifications of processes appropriately made by one skilled in the art in regard to the exemplary embodiments described above are within the scope of the invention to the extent that the purport of the invention is included.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

1. A template, comprising an unevenness provided on a first major surface,
a side wall of the unevenness having a trench aligned in a depth direction of the unevenness.

2. The template according to claim 1, wherein
a depth of the trench along a first direction orthogonal to the depth direction of the unevenness is not more than 1/10 of a width along the first direction of a protruding portion of the unevenness.

3. The template according to claim 1, wherein the side wall further includes an ultra-fine unevenness having a depth shallower than the depth of the trench.

4. The template according to claim 3, wherein the ultra-fine unevenness is made by wet processing.

5. The template according to claim 1, wherein the unevenness has a trench configuration aligned in one direction.

6. The template according to claim 1, wherein a configuration of the unevenness as viewed along the depth direction is at least one selected from rectangular, square, polygonal, flattened circular, and circular.

7. The template according to claim 1, wherein the unevenness has a protruding portion, a width of the protruding portion along a first direction orthogonal to the depth direction of the unevenness being not less than 10 nanometers and not more than 1 micrometer.

8. The template according to claim 7, wherein a width of the protruding portion along a second direction orthogonal to the first direction and the depth direction of the unevenness is not less than 20 micrometers and not more than 100 micrometers.

9. The template according to claim 1, wherein the depth of the unevenness is not less than 10 nanometers and not more than 200 nanometers.

10. The template according to claim 1, wherein a depth of the trench along a first direction orthogonal to the depth direction of the unevenness is not less than 1 nanometer and not more than 20 nanometers.

11. The template according to claim 1, wherein a width of the trench along a second direction orthogonal to the first direction and the depth direction of the unevenness is not less than 1 nanometer and not more than 100 nanometers.

12. The template according to claim 11, wherein the trench is multiply provided and a spacing between the plurality of trenches is not less than 1 nanometer and not more than 100 nanometers.

13. The template according to claim 1, wherein,
the unevenness has a protruding portion,
the trench is multiply provided,
the plurality of trenches has a depth along a first direction orthogonal to the depth direction of the unevenness and has a width along a second direction orthogonal to the first direction and the depth direction, and
a length along the second direction of at least one selected from the width of each of the plurality of trenches and the spacing between the plurality of trenches is not more than 1/10 of a length along the second direction of the protruding portion of the unevenness.

14. The template according to claim 1, wherein the template includes quartz.

15. The template according to claim 1, wherein a configuration of the trench as viewed along the depth direction of the unevenness is at least one selected from a triangular configuration and a wave-like configuration.

16. The template according to claim 1, wherein the side wall of the unevenness has a flat portion.

17. The template according to claim 1, wherein a bottom face of the trench has a flat portion.

18. A pattern formation method, comprising:
transferring a pattern of an unevenness provided on a first major surface of a template onto a transfer material provided on a major surface of a processing substrate by bringing the first major surface into contact with the transfer material,
the template having a trench provided in a side wall of the unevenness to align in a depth direction of the unevenness.

19. The template according to claim 18, wherein
a depth of the trench along a first direction orthogonal to the depth direction of the unevenness is not more than 1/10 of a width along the first direction of a protruding portion of the unevenness.

20. The method according to claim 18, wherein
the transferring includes separating the transfer material and the template from each other, and
the separating includes changing relative positions of the transfer material and the unevenness of the template along a direction tilted with respect to the depth direction.
